(19) United States
(12) Patent Application Publication
(10) Pub. No.: US 2019/0063005 A1
(43) Pub. Date: Feb. 28, 2019

(54) PORTABLE, FOLDABLE PATHWAY FOR WHEELED DEVICES

(71) Applicant: Access Trax, LLC, La Jolla, CA (US)

(72) Inventors: Kelly D. Twichel, La Jolla, CA (US); Eric A. Packard, La Jolla, CA (US)

(21) Appl. No.: 16/056,784

(22) Filed: Aug. 7, 2018

Related U.S. Application Data
(60) Provisional application No. 62/550,901, filed on Aug. 28, 2017.
(60) Provisional application No. 62/635,420, filed on Feb. 26, 2018.

(51) Int. Cl. E01C 9/08; E05D 1/02

(52) U.S. Cl. CPC E01C 9/086; E01C 2201/16; E05D 1/02

(57) ABSTRACT

A portable pathway for a wheeled object to be rolled on over uneven terrain, comprising: a plurality of track members with perforations therein; one or more hinges coupling adjacent track members together to form the pathway that the wheeled object rolls over, wherein the pathway is foldable, customizable in length, and the perforations in the track members decrease the weight of the track members and provide traction relative to the terrain by allowing the terrain to extend up into the perforations, securing the track members in position on the terrain.

### CROSS-REFERENCE TO RELATED APPLICATIONS

This application claims priority to U.S. Provisional Patent Application No. 62/550,901, filed Aug. 28, 2017 and U.S. Provisional Patent Application No. 62/635,420, filed Feb. 26, 2018, both of which are incorporated by reference herein.

### FIELD OF THE INVENTION

The invention relates to semi-permanent pathways for wheeled devices.

### BACKGROUND OF THE INVENTION

Many private and public businesses and locations lack permanent accessible pathways over uneven terrain. Standard wheelchairs cannot propel through terrain such as grass, sand, and gravel which causes a barrier. The Americans with Disabilities Act mandates fair access to public accommodations, but compliance is still lacking across the United States. Other wheeled devices such as strollers and carts are also difficult to propel over uneven terrain where a permanent pathway is not available.

Current available solutions include: installing a permanent pathway at the expense of the business owner/entity, modifying the wheeled device to have bigger or more efficient wheels to navigate the terrain, or purchase/rent a semi-permanent pathway. Drawbacks of the above include: installing a permanent pathway may alter the integrity of the environment or prove too costly, and modifying the wheeled device may not be cost-effective and requires the user to perform manual labor to switch the wheels. Using a semi-permanent pathway may be the best solution depending on the method required to set up the pathway.

Semi-permanent pathways such as Mobi-Mat™ and AccessMat™ are both roll-out woven polyester semi-permanent pathways. These mats both require two able-bodied persons to install and take a minimum of 10 minutes to lay out 33 feet. They are also very expensive, with minimum costs for 33 feet at $1500-2200, which is not cost effective for an individual. The storage and transport is also difficult since they roll up and do not lay flat. Finally, they are not rigid and conform to the undulations of the terrain beneath, which can make propelling a wheeled device difficult. A company called FastDeck produces multiple products that are designed as rigid temporary flooring squares or rectangles that snap together to cover the surface below. This product takes substantially more time and labor to set up than the other solutions (ex. 1-2 hours for a 5 foot wide pathway 60 feet long), and requires a relatively flat terrain beneath.

### SUMMARY

An aspect of the invention involves a portable, foldable, lightweight, temporary pathway designed to provide wheeled access for a wheeled object such as a wheelchair where a permanent pathway does not exist. The portable pathway has removable hinges, allowing a person to customize the length of track carried and deployed at one time based on their physical ability level, thus reducing the amount of persons required for set-up and transport.

Another aspect of the invention involves a portable pathway for a wheeled object to be rolled on over uneven terrain. The portable pathway comprises a plurality of track members with perforations therein; one or more hinges coupling adjacent track members together to form the pathway that the wheeled object rolls over, wherein the pathway is foldable, customizable in length, and the perforations in the track members decrease the weight of the track members and provide traction relative to the terrain by allowing the terrain to extend up into the perforations, securing the track members in position on the terrain.

One or more implementations of the aspect of the invention described immediately above includes one or more of the following: the plurality of track members have a substantially rectangular configuration and are made of a thin, flat, rigid polyethylene plastic which is UV stable; the track members include hinge receiving holes on all ends and sides, allowing the track members to be connected to each other end-to-end and side-to side via the hinges and the hinge receiving holes when the track members are placed to allow opposing hinge holes of adjacent track members to align; the hinges are lightweight straps including hook and loop fasteners to couple adjacent track members together via the hinge receiving holes; the pathway unfolds and folds in an accordion style, and when track members are connected via the hinges and folded, the pathway becomes stacked into a compact configuration, making set-up, transport, and storage quick and easy; the one or more hinges are flexible, allowing the pathway to be folded and stacked and unfolded and deployed over the uneven terrain; the perforations in track members align when the track members are stacked, and further including a carrying strap disposed in the one or more of the perforations for carrying the portable pathway; the wheeled object includes wheels, and the track members include a texturized upper surface to provide slip-resistance with the wheels of the wheeled object; the texturized upper surface of the track members has a hair cell texture; the track members have an upper surface, the wheeled object is a wheelchair with wheels spaced up to 26 inches apart, and the track members are sized to allow for a full 360 degree turn-in-place of the wheelchair when the wheels touch the upper surface of the track members; the wheeled object includes wheels, and the coupled adjacent track members have a space there between that is sufficiently small enough to prevent entrapment of the wheels of the wheeled object yet large enough to allow for folding in an accordion style; the space between coupled adjacent track members is between ⅛ inch and ½ inch; and/or anchors received in the perforations to anchor the pathway to the uneven terrain.

A further aspect of the invention involves a method of using the portable pathway in the aspect of the invention described immediately above. The method comprises the portable pathway being transported with the track members hinged together in a stacked configuration to the uneven terrain; the track members being unfolded in an accordion style onto the uneven terrain; receiving of the uneven terrain up into the perforations, securing the track members in position on the uneven terrain; receiving the wheeled object rolled over the track members over the uneven terrain.

A still further aspect of the invention involves a method of using the portable pathway in the aspect of the invention described immediately above. The method comprises the track members being together in an accordion style so as to create a stacked configuration of the track members; the portable pathway with the track members in the stacked configuration being transported from the uneven terrain.

### BRIEF DESCRIPTION OF DRAWINGS

FIG. 1 is a perspective view of an embodiment of a portable, foldable pathway shown deployed on a sand surface such as at a beach;

FIG. 2 is a top plan view of an embodiment of a track member of a portable, foldable pathway;

FIG. 3 is a top perspective view of a section of the embodiment of the portable, foldable pathway referred to in FIG. 2;

FIG. 4 is a perspective view of an embodiment of a hinge of the portable, foldable pathway;

FIG. 5 is a perspective view of an embodiment of a portable, foldable pathway of FIG. 1 shown in a folded configuration, ready for transport.

### DETAILED DESCRIPTION OF THE INVENTION

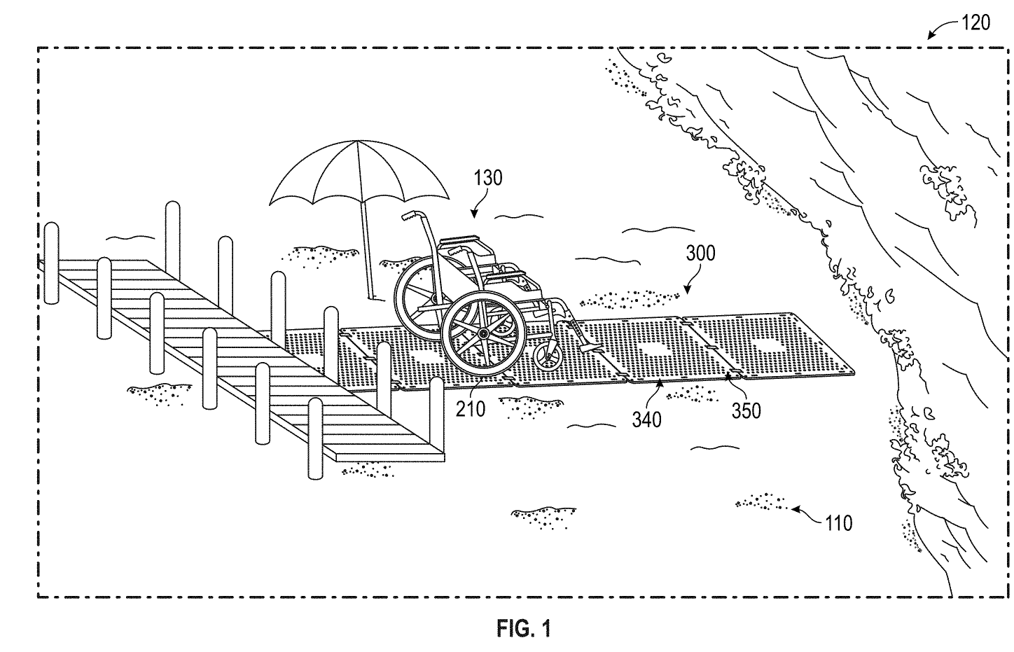

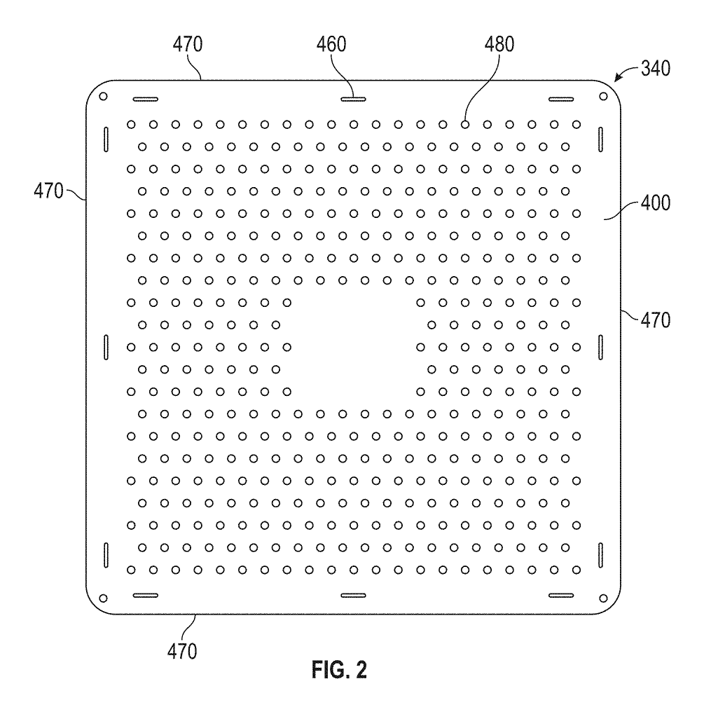

With reference to FIGS. 1-5, an embodiment of a portable, foldable, lightweight, temporary pathway (“pathway”) 300 designed to provide wheeled access where a permanent pathway does not exist will be described. Although the pathway 300 is shown in FIG. 1 deployed over sand 110 at a beach 120, the pathway 300 may be deployed onto any relatively flat terrain where it is desirable to transport a wheeled object such as wheelchair 130 over the terrain where, without the pathway, transport of the wheeled object over the terrain would be difficult or impossible.

The pathway 300 includes a plurality of track members 340 interconnected to each other through hinges 350. In the embodiment shown, the track members 340 are made of rigid polyethylene plastic which is UV stable. From a plan view, the track members 340 have a flat configuration forming a substantially 3 ft×3 ft square.

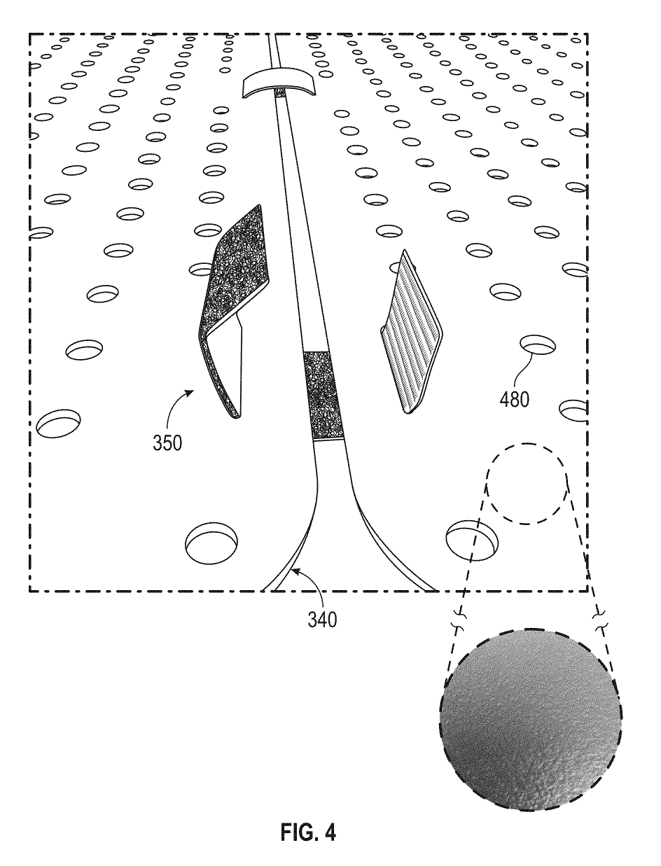

Each track member 340 has an upper face/surface 400 that wheels 210 of the wheelchair 130 roll upon. As shown in FIG. 4, this upper face 400 is texturized, with a hair cell texture, for a slip-resistant surface with the wheels of the wheeled object/wheelchair. The track members 340 have hinge receiving holes/slits 460 (e.g., sets of three slits 460) on all four sides 470. Although sets of three slits 460 are shown adjacent to the sides 470, in alternative embodiments, the track members 340 have other numbers of slits 460. The track members 340 are also perforated with holes/perforations 480 to keep the track members 340 lightweight and assist with grip for the underlying terrain by allowing the underlying terrain to extend up into the holes 480, helping to secure/grip the track members 340 in position on the terrain.

With reference to FIGS. 1 & 3-5, the hinges 350 are light-weight straps including hook and loop fasteners (e.g., Velcro® brand hook and loop fasteners sold by VELCRO INDUSTRIES B.V. CORPORATION of the NETHERLANDS) which fit through the track hinge slits 460 to connect track members 340 to each other by securing the hook and loop fasteners of the straps together.

One of the advantages of the pathway 300 is that the length and configuration of the pathway 300 is customizable. Although the pathway 300 may come in a standard length (e.g., 30 ft.), the length of the pathway 300 is customizable; the plurality of track members 340 are connected together end-to-end or side-to-side via pairs of removable hinges 350 until a desired pathway length and configuration is achieved. Each hinge 350 is connected to the hinge receiving hole/slit 460 of the track member 340 adjacent to the side 470. Because the hinges 350 are made of straps with easily detachable hook and loop fasteners, they can also be easily be removed from the hinge receiving hole/slit 460, for example, when it is desired to shorten or extend the pathway length.

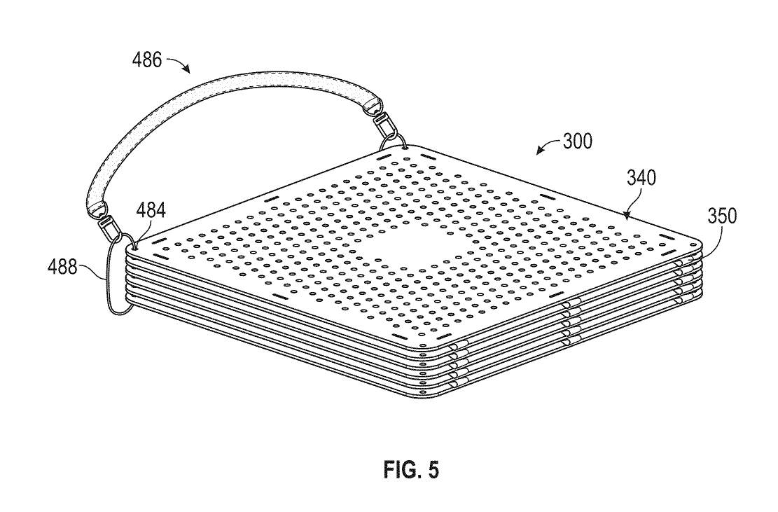

As shown in FIG. 5, another advantage of the pathway 300 is that the flexible nature of the hinges 350 allows the pathway 300 to fold and unfold in an accordion style, and require only one able-bodied person for set up. The flexible hinges 350 decrease set up time and labor, and make the pathway 300 more portable and storable. The pathway 300 is collapsible/foldable into a compact configuration (e.g., 30 ft. pathway 300 is foldable into thickness of under 4 in.). The compact configuration of the collapsed pathway 300 along with the light-weight nature of the plastic track members 340 and hinges (e.g., light-weight straps with hook and loop fasteners) 350 makes the pathway easy to transport and store. In one embodiment, the pathway 300 weighs less than 60 lbs for 30 feet including hinges 350. As shown in FIG. 5, when corner perforations 484 in track members 340 align when the track members 340 are stacked, a carrying strap 486 disposed in the corner perforations 484 can be used for carrying the portable pathway 300. The carrying strap 486 may include a pair of loops 488 that are disposed in the corner perforations 484 to maintain the track members 340 in a stacked configuration.

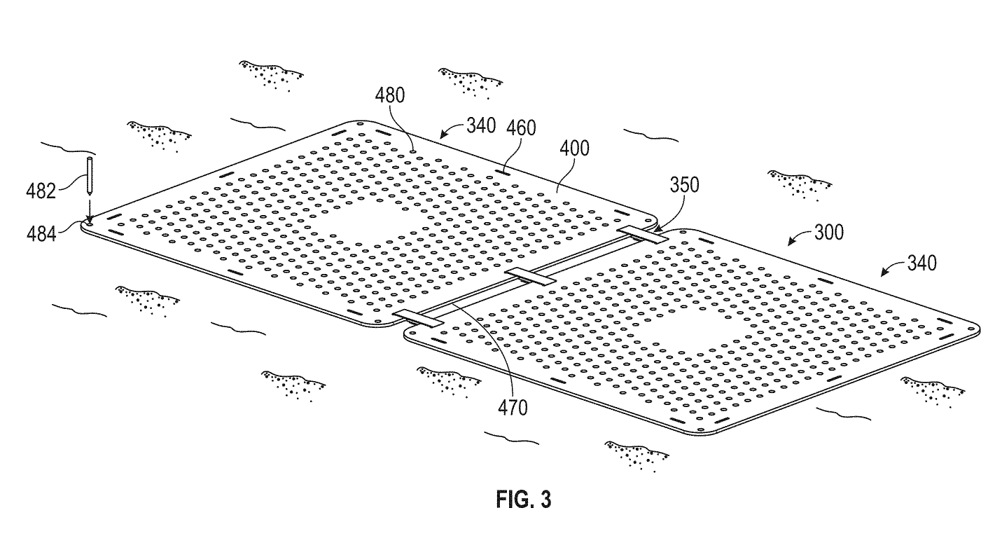

Once the pathway 300 is transported to a desired location, the pathway 300 is deployed onto the terrain (e.g., beach 120) by unfolding the pathway 300 to an elongated linear configuration such as that shown in FIG. 1. As shown in FIG. 3, anchor(s) (e.g., stake(s)) 482 may be provided in corner perforations 484 to anchor the pathway 300 to the uneven terrain. A person such as an adaptive surfer (e.g., spinal cord injury survivor) who requires access over the sand 110 at the beach 120 to participate in leisure wheels over the pathway 300 across the sand 110 at the beach 120. During transportation over the pathway 300 to a desired destination on the beach 120 over the sand 110, the wheels 200 of the wheelchair 130 easily roll over the upper faces 400 of the track members 340 to the desired destination on the beach 120. The track members 340 are sized to allow the wheelchair, with wheels spaced as much as 26 inches apart, to do a full 360 degree turn-in-place when the wheels touch the upper surface 400 of the track members 340. If the pathway 300 is not long enough to reach a desired destination on the beach 120, the pathway 300 may be extended by coupling additional track members 340 end-to-end by with additional hinges 350. The track members 340 are added by inserting the hinges 350 into corresponding receiving holes/slits 460 of adjacent, end-to-end track members 340 to couple the adjacent, end-to-end track members 340 together. If track members 340, in addition to those used in the existing pathway 300, are not available, then one can uncouple and remove the track members 340 of the existing pathway 300 (that the wheelchair 130 has already rolled over). The track members 340 are removed by removing the hinges 350 from the corresponding receiving holes/slits 460 of adjacent, end-to-end track members 340. Then, those previously removed track members are coupled/added end-to-end to the existing pathway 300 in the manner described above to extend the pathway 300 to a desired destination on the beach 120.

While various embodiments of the present invention have been described above, it should be understood that they have been presented by way of example only, and not of limitation. Likewise, the various diagrams may depict an example architectural or other configuration for the disclosure, which is done to aid in understanding the features and functionality that can be included in the disclosure. The invention is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the present disclosure.

Although the disclosure is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the disclosure, whether or not such embodiments are described and whether or not such features are presented as being a part of a described embodiment. Thus, the breadth and scope of the present disclosure should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent.

As will become apparent to one of ordinary skill in the art after reading this document, the illustrated embodiments and their various alternatives can be implemented without confinement to the illustrated examples.

We claim:

1. A portable pathway for a wheeled object to be rolled on over uneven terrain, comprising:
a plurality of track members with perforations therein;
one or more hinges coupling adjacent track members together to form the pathway that the wheeled object rolls over,
wherein the pathway is foldable, customizable in length, and the perforations in the track members decrease the weight of the track members and provide traction relative to the terrain by allowing the terrain to extend up into the perforations, securing the track members in position on the terrain.

2. The portable pathway of claim 1, wherein the plurality of track members have a substantially rectangular configuration and are made of a thin, flat, rigid polyethylene plastic which is UV stable.

3. The portable pathway of claim 2, wherein the track members include hinge receiving holes on all ends and sides, allowing the track members to be connected to each other end-to-end and side-to side via the hinges and the hinge receiving holes when the track members are placed to allow opposing hinge holes of adjacent track members to align.

4. The portable pathway of claim 1, wherein the hinges are lightweight straps including hook and loop fasteners to couple adjacent track members together via the hinge receiving holes.

5. The portable pathway of claim 1, wherein the pathway unfolds and folds in an accordion style, and when track members are connected via the hinges and folded, the pathway becomes stacked into a compact configuration, making set-up, transport, and storage quick and easy.

6. The portable pathway of claim 1, wherein the one or more hinges are flexible, allowing the pathway to be folded and stacked and unfolded and deployed over the uneven terrain.

7. The portable pathway of claim 1, wherein the perforations in track members align when the track members are stacked, and further including a carrying strap disposed in the one or more of the perforations for carrying the portable pathway.

8. The portable pathway of claim 1, wherein the wheeled object includes wheels, and the track members include a texturized upper surface to provide slip-resistance with the wheels of the wheeled object.

9. The portable pathway of claim 8, wherein the texturized upper surface of the track members has a hair cell texture.

10. The portable pathway of claim 1, wherein the track members have an upper surface, the wheeled object is a wheelchair with wheels spaced up to 26 inches apart, and the track members are sized to allow for a full 360 degree turn-in-place of the wheelchair when the wheels touch the upper surface of the track members.

11. The portable pathway of claim 1, wherein the wheeled object includes wheels, and the coupled adjacent track members have a space there between that is sufficiently small enough to prevent entrapment of the wheels of the wheeled object yet large enough to allow for folding in an accordion style.

12. The portable pathway of claim 11, wherein the space between coupled adjacent track members is between ⅛ inch and ½ inch.

13. The portable pathway of claim 1, further including anchors received in the perforations to anchor the pathway to the uneven terrain.

14. A method of using the portable pathway of claim 1, comprising:
portable pathway being transported with the track members hinged together in a stacked configuration to the uneven terrain;
the track members being unfolded in an accordion style onto the uneven terrain;
receiving of the uneven terrain up into the perforations, securing the track members in position on the uneven terrain;
receiving the wheeled object rolled over the track members over the uneven terrain.

15. The method of using the portable pathway of claim 14, further comprising:
the track members being together in an accordion style so as to create a stacked configuration of the track members;
the portable pathway with the track members in the stacked configuration being transported from the uneven terrain.
